(19) United States
(12) Patent Application Publication
(10) Pub. No.: US 2025/0362151 A1
(43) Pub. Date: Nov. 27, 2025

(54) SYSTEMS AND METHODS FOR GENERATING A REPRESENTATION OF A SPACE

(71) Applicant: INTERAPTIX INC., Toronto (CA)

(72) Inventors: Dae Hyun LEE, Etobicoke (CA); Tyler James DOYLE, Toronto (CA); Isaac Louis Gold BERMAN, Toronto (CA)

(21) Appl. No.: 18/873,664

(22) PCT Filed: Jun. 12, 2023
(86) PCT No.: PCT/IB2023/056053

§ 371 Date: Dec. 10, 2024

Related U.S. Application Data
(60) Provisional application No. 63/351,680, filed on Jun. 13, 2022.

(51) Int. Cl. G01C 21/00

(52) U.S. Cl. CPC G01C 21/383; G01C 21/3837

(57) ABSTRACT

An example method of generating a representation of a space includes: segmenting the space into a plurality of regions; defining a global anchor map defining at least one anchor point in association with each region and locating the anchor points within the space according to a global frame of reference; obtaining, for each region, a local representation representing the region according to a local frame of reference; generating a global representation in the global frame of reference based on the local representation, the at least one anchor point associated with each region, and the global anchor map; and storing the global representation as the representation of the space.

### CROSS-REFERENCE TO RELATED APPLICATION(S)

This application claims the benefit of U.S. Provisional Patent Application No. 63/351,680, filed Jun. 13, 2022, entitled “SYSTEMS AND METHODS FOR GENERATING A REPRESENTATION OF A SPACE”; the entire contents of which are incorporated herein by reference.

### FIELD

The specification relates generally to systems and methods for virtual representations of spaces, and more particularly to a system and method for generating a representation of a space with reduced drift.

### BACKGROUND

Virtual representations of spaces may be captured using data capture devices to capture image data, depth data, and other relevant data to allow the representation to be generated. When the spaces are large, the data capture devices may experience spatial drift over large distances, which may cause visually discrepancies.

### SUMMARY

According to an aspect of the present specification an example method includes: segmenting the space into a plurality of regions; defining a global anchor map defining at least one anchor point in association with each region and locating the anchor points within the space according to a global frame of reference; obtaining, for each region, a local representation representing the region according to a local frame of reference; generating a global representation in the global frame of reference based on the local representation, the at least one anchor point associated with each region, and the global anchor map; and storing the global representation as the representation of the space.

According to another aspect of the present specification, an example server includes: a memory and a communications interface; and a processor interconnected with the memory and the communications interface, the processor configured to: segment a space into a plurality of regions; define a global anchor map defining at least one anchor point in association with each region and locating the anchor points within the space according to a global frame of reference; obtain, for each region, a local representation representing the region according to a local frame of reference; generate a global representation in the global frame of reference based on the local representation, the at least one anchor point associated with each region, and the global anchor map; and store the global representation of the space.

### BRIEF DESCRIPTION OF DRAWINGS

Implementations are described with reference to the following figures, in which:

FIG. 1 depicts a block diagram of an example system for generating a representation of a space with reduced spatial drift.

FIG. 2 depicts a flowchart of an example method of generating a representation of a space with reduced spatial drift.

FIG. 3A depicts a schematic diagram of a layout map for a space.

FIG. 3B depicts a schematic diagram of a segmentation plan for the space of FIG. 3A.

FIG. 4A-4C depict flowcharts of example methods of defining a global reference map at block 210 of the method of FIG. 2.

FIG. 5 depicts a flowchart of an example method of obtaining local representations at block 215 of the method of FIG. 2.

FIGS. 6A and 6B depict schematic diagrams of transforming a local representation to a global representation.

### DETAILED DESCRIPTION

Data capture devices may naturally experience spatial drift over time, and in particular over large distances. Accordingly, representations of large spaces may experience the same spatial drift between a starting and ending point of the captured representation. Such spatial drift can cause visual discrepancies if the same point (or region) is captured at different points in time (e.g., at the beginning of the capture operation and the end of the capture operation) and spatial drift has occurred.

Accordingly, according to the present example, a system may utilize local representations to capture smaller segmented regions of a space for which little to no spatial drift occurs over the local frame of reference. In order to stitch the local representations together, each local representation may be associated with an anchor point. The anchor points, in turn, are defined in a global anchor map which locates the anchor points according to a global frame of reference. The locations of the anchor points in the global anchor map are also defined in a manner that little to no spatial drift occurs, for example, by physical measurement, or by defining the anchor points sufficiently close to minimize spatial drift.

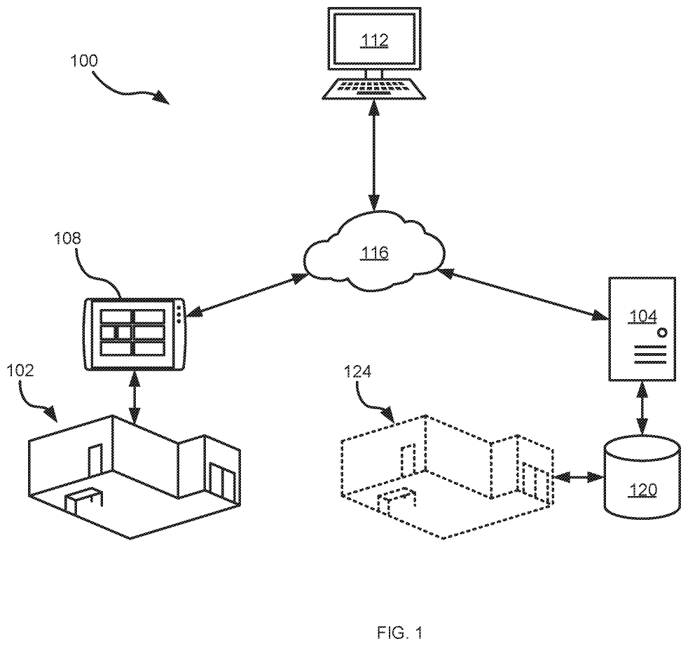

FIG. 1 depicts a block diagram of an example system 100 for generating a representation of a space 102. For example, space 102 can be a factory or other industrial facility, an office a new building, a private residence, or the like. In other examples, the space 102 can be a scene including any real-world location or object, such as a construction site, a vehicle such as ship, equipment, or the like. It will be understood that space 102 as used herein may refer to any such scene, object, target, or the like. System 100 includes a server 104 and a client device 112 which are preferably in communication via a network 116. System 100 additionally includes a data capture device 108 which can also be in communication with at least server 104 via network 116.

Server 104 is generally configured to generate a representation of space 102 with increased accuracy and reduced drift over larger distances within space 102. In particular, the method used by server 104 to generate the representation of space 102 may generate a more accurate representation of larger spaces, such as a large building including multiple connected rooms, hallways, etc., or an extensive exterior space, or similar. Server 104 can be any suitable server or computing environment, including a cloud-based server, a series of cooperating servers, and the like. For example, server 104 can be a personal computer running a Linux operating system, an instance of a Microsoft Azure virtual machine, etc. In particular, server 104 includes a processor and a memory storing machine-readable instructions which, when executed, cause server 104 to generate a representation of space 102, as described herein. Server 104 can also include a suitable communications interface (e.g., including transmitters, receivers, network interface devices and the like) to communicate with other computing devices, such as client device 112 via network 116.

Data capture device 108 is a device capable of capturing relevant data such as image data, depth data, audio data, other sensor data, combinations of the above and the like. Data capture device 108 can therefore include components capable of capturing said data, such as one or more imaging devices (e.g., optical cameras), distancing devices (e.g., LIDAR devices or multiple cameras which cooperate to allow for stereoscopic imaging), microphones, and the like. For example, data capture device 108 can be an IPad Pro, manufactured by Apple, which includes a LIDAR system and cameras, a head-mounted augmented reality system, such as a Microsoft Hololens™, a camera-equipped handheld device such as a smartphone or tablet, a computing device with interconnected imaging and distancing devices (e.g., an optical camera and a LIDAR device), or the like. Data capture device 108 can implement simultaneous localization and mapping (SLAM), 3D reconstruction methods, photogrammetry, and the like. The actual configuration of data capture device 108 is not particularly limited, and a variety of other possible configurations will be apparent to those of skill in the art in view of the discussion below.

Data capture device 108 additionally includes a processor, a non-transitory machine-readable storage medium, such as a memory, storing machine-readable instructions which, when executed by the processor, can cause data capture device 108 to perform data capture operations. Data capture device 108 can also include a display, such as an LCD (liquid crystal display), an LED (light-emitting diode) display, a heads-up display, or the like to present a usual with visual indicators to facilitate the data capture operation. Data capture device 108 also includes a suitable communications interface to communicate with other computing devices, such as server 104 via network 116.

Client device 112 is generally configured to present a representation of space 102 to a user and allow the user to interact with the representation, including providing inputs and the like, as described herein. Client device 112 can be a computing device, such as a laptop computer, a desktop computer, a tablet, a mobile phone, a kiosk, or the like. Client device 112 includes a processor and a memory, as well as a suitable communications interface to communicate with other computing devices, such as server 104 via network 116. Client device 112 further includes one or more output devices, such as a display, a speaker, and the like, to provide output to the user, as well as one or more input devices, such as a keyboard, a mouse, a touch-sensitive display, and the like, to allow input from the user.

Network 116 can be any suitable network including wired or wireless networks, including wide-area networks, such as the Internet, mobile networks, local area networks, employing routers, switches, wireless access points, combinations of the above, and the like.

System 100 further includes a database 120 associated with server 104. For example, database can be one or more instances of My SQL or any other suitable database. Database 120 is configured to store data to be used to identify changes in space 102. In particular, database 120 is configured to store a persistent representation 124 of space 102. In particular, representation 124 may be a global 3D representation which tracks persistent spatial information over time. Additionally, representation 124 may be used to track virtual spatial anchors. Other representations, including 2D representations (e.g., optical images, thermal images, etc.) and 3D representations (e.g., 3D scans, including partial scans, depth maps, etc.) may also be stored at database 120. Database 120 can be integrated with server 104 (i.e., stored at server 104), or database 120 can be stored separately from server 104 and accessed by the server 104 via network 116.

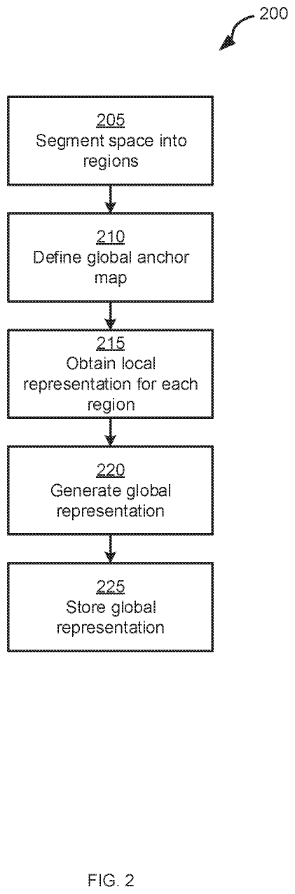

Referring to FIG. 2, an example method 200 of generating a representation of space 102 is depicted. Method 200 is described below in conjunction with its performance by server 104, however in other examples, method 200 may be performed by other suitable devices or systems. In some examples, functionality described in relation to client device 112 may be performed by data capture device 108 and vice versa. Additionally, in some examples, some of the blocks of method 200 can be performed in an order other than that illustrated, and hence are referred to as blocks and not steps.

At block 205, space 102 may be segmented into a plurality of regions, either independently or based on user input. The segmentation of space 102 may be performed by server 104, or in some examples, by data capture device 108. The regions represents volumes of space (i.e., capture volumes) which are sufficiently small that data captured experiences little to no spatial drift, or for which the drift experienced is below a threshold tolerance. Accordingly, when performing independent space segmentation, server 104 may segment space 102 such that each region has at most a threshold size. In some examples, the threshold size may simply be a volumetric capacity, while in other examples, the threshold size may define thresholds for individual dimensions (e.g., a length, width and height), and/or for combinations of dimensions.

Additionally, space 102 may preferably be segmented logically into regions such that, for example, a single region does not include portions of adjacent rooms separated by a wall or other physical layout feature which would substantially obstruct the data capture operation. Accordingly, server 104 may obtain a layout map defining the physical layout features (e.g., walls, doors, posts, changes in elevation, and the like) of space 102 and segment the space according to the physical layout features of the space. That is, server 104 may define the boundaries of various regions to correspond with the physical layout features of space 102. The layout map may be a 2D map, such as a floor plan, or a 3D map, such as representation 124 stored at database 120, or other 3D scan or representation of space 102.

In addition to the physical layout features, server 104 may additionally apply the threshold size described above to the regions. For example, if a region defined solely by the physical layout features exceeds the threshold size, server 104 may further subdivide the region to conform with the threshold size criteria. In particular, such region segmentation may be dynamic, for example so that the regions are approximately equally sized, so that the regions have a regular shape (i.e., approximately a rectangular prism), or other relevant and/or desired criteria for the regions.

In some examples, additionally or alternately, server 104 may receive a user definition of the regions of space 102, for example received as input at client device 112 or data capture device 108 to allow a user to segment space 102 based, for example, on more functional uses of the space or other criteria not detectable from a layout map by server 104.

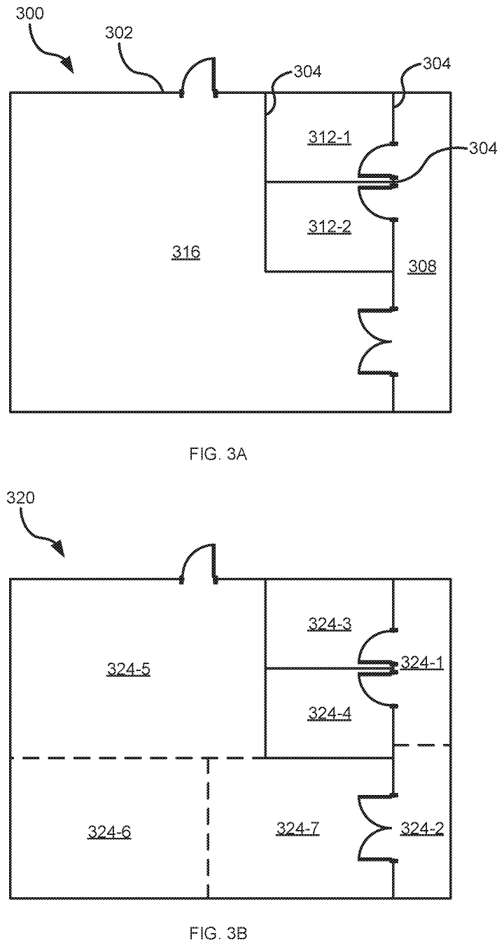

For example, referring to FIG. 3A, an example layout map 300 is provided. In the present example, layout map 300 is a 2D floor plan of a space 302. Server 104 may identify walls 304, dividing space 102 into a hallway 308, first and second bathrooms 312-1, 312-2, and a main room 316.

FIG. 3B depicts a segmentation plan 320 of space 302. Server 104 may identify, for example, that while an overall size (i.e., area) of hallway 308 is below the threshold size, hallway 308 nevertheless has a length exceeding a threshold length, and hence may segment hallway 308 into regions 324-1 and 324-2. Server 104 may additionally determine that first and second bathrooms 312-1 and 312-2 are sufficiently small and hence may each be assigned their own region 324-3 and 324-4. Finally, server 104 may determine that main room 316 is above the threshold size, and hence may segment main room 316 into regions 324-5, 324-6, and 324-7. In particular, server 104 may perform the segmentation of main room 316d in consideration of the threshold size, individual threshold dimensions (i.e., length and width), as well as to maintain approximately regular (i.e., rectangular) regions.

Returning to FIG. 2, at block 210, server 104 may define a global anchor map. The global anchor map defines at least one anchor point in association with each region defined at block 205. Additionally, the global anchor map locates the anchor points within space 102 according to a global frame of reference.

The anchor points may be physical features located within the region, virtual spatial anchors located within the region, determined locations located within each region, or the like. The manner of generating the global anchor map may vary according to the type of anchor points used.

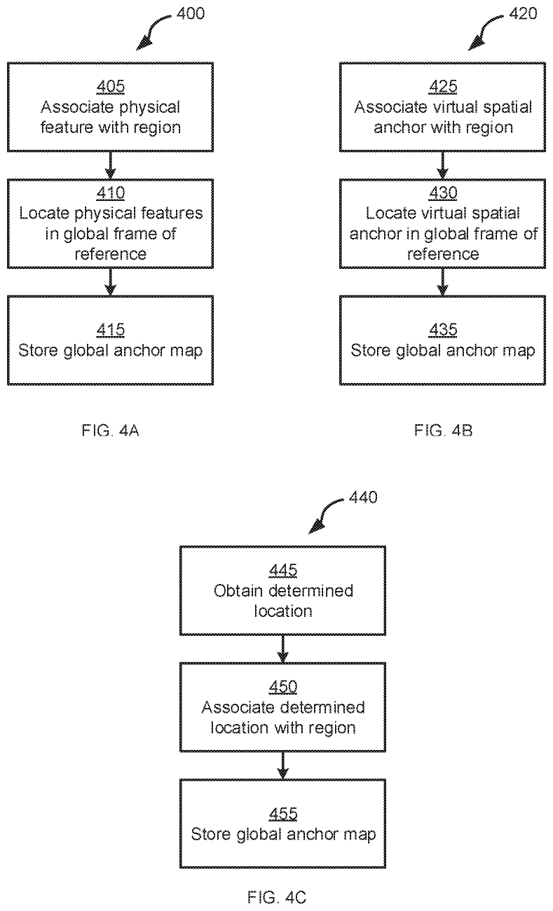

For example, referring to FIG. 4A an example method 400 of defining a global anchor map using physical features as anchor points is depicted. The physical features may be, for example a QR code, barcode or other identifier physically located within the region. In other examples, another physical feature may be a persistent physical spatial feature within the region.

At block 405, server 104 defines, for each region, a physical feature as an anchor point and associates the physical feature to the corresponding region. For example, server 104 may associate an identifier encoded by a QR code with the region in which the QR code is located. As will be appreciated, a representation of the QR code may additionally be placed in the region by a user.

At block 410, server 104 locates the physical features in a global frame of reference for space 102. For example, server 104 may obtain physical distances between the physical feature of a given region and another physical feature in another region. In particular, the physical features are defined with respect to the same global frame of reference, with the distances being defined by said global frame of reference. For example, the global frame of reference may be defined by physical distances. In such examples, a user may physically measure the distance between physical features and provide the measured distances as input from client device 112 and/or data capture device 108. The distances between physical features may additionally include directional information to locate the physical features relative to one another, including both a relative XY direction (e.g., direction in the plane of the ground), as well as a relative Z information (e.g., height relative to the ground) between the physical features. In other examples, in addition to or alternately to the relative distances, the global frame of reference may define a coordinate system, to allow the physical features to be defined at objective coordinate positions, rather than relative positions.

In other examples, rather than measuring the physical distance between the physical features, a user may employ data capture device 108 to determine the distance and direction between the physical features. Data capture device 108 may capture image and/or depth data to localize itself within space 102 and establish a frame of reference. Data capture device 108 may then identify a first physical feature used as an anchor point and then the user may move data capture device 108 within space 102 to identify a second physical feature. As data capture device 108 moves between the first and second physical features, data capture device 108 tracks its location within the established frame of reference to allow data capture device 108 to determine a distance and direction between the first and second physical features. As will be appreciated, as the user moves data capture device 108 between further physical features corresponding to further anchor points, the accuracy of the mapping of the anchor points may increase.

Accordingly, in such examples, the physical features may be selected to be within a threshold distance from one another, such that data capture device 108 experiences little to no drift between the physical features. The established frame of reference of data capture device 108 may thus be defined as the global frame of reference.

In some examples, in addition to obtaining relative distances between the physical features used as anchor points, server 104 may additional obtain distances between the physical features and physical layout features of space 102, such as doors, walls, and the like.

At block 415, server 104 stores the physical features as anchor points in association with their corresponding regions, and locates them within space 102 in the global anchor map based on the global frame of reference. The global anchor map may additionally locate the physical features relative to the physical layout features. That is, the global anchor map may be substantially overlaid on a layout map of space 102. The global anchor map may be stored in database 120 for future reference.

FIG. 4B depicts another example method 420 of defining a global anchor map using virtual spatial anchors as anchor points. The virtual spatial anchors may be for example, spatial anchors defined in a communal space, such as the spatial anchors utilized by Microsoft Azure. The virtual spatial anchors may be located or anchored to real-world physical features or the like. In other examples, the virtual spatial anchors may be defined relative to one another within the global anchor map.

At block 425, server 104 defines, for each region, a virtual spatial anchor as an anchor point and associates the virtual spatial anchor to the corresponding region. For example, to define a virtual spatial anchor for a region, a user may utilize data capture device 108. In particular, data capture device 108 may capture image and/or depth data to localize itself within space 102, and in particular in the region of interest. The user may designate a location at which to define a virtual spatial anchor via input at data capture device 108. Data capture device 108 may additionally capture distinguishable physical features of and around the location to allow the virtual spatial anchor to be associated with a physical location. Server 104 may then store the location of the virtual spatial anchors including any distinguishable physical features to locate the virtual spatial anchor within space 102. Server 104 may then associate the virtual spatial anchor with the region in which the virtual spatial anchor is located (i.e., based on the location of the distinguishable physical features associated with the virtual spatial anchor).

At block 430, server 104 locates the virtual spatial anchor in a global frame of reference for space 102. For example, a user may employ data capture device 108 determine the distance and direction between virtual spatial anchors. Data capture device 108 may capture image and/or depth data to localize itself within space 102 and establish a frame of reference. Data capture device 108 may then identify a first virtual spatial anchor and then the user may move data capture device 108 within space 102 to identify a second virtual spatial anchor. As the user moves between the first and second virtual spatial anchors, data capture device 108 tracks its location within the established frame of reference to allow data capture device 108 to determine a distance and direction between the first and second virtual spatial anchors.

Accordingly, the virtual spatial anchors may be selected to be within a threshold distance from one another, such that data capture device 108 experiences little to no drift between the virtual spatial anchors. The established frame of reference may thus be defined as the global frame of reference.

In some examples, in addition to determining the distance and direction between the virtual spatial anchors based solely on data captured by data capture device 108, server 104 may additionally triangulate a location of data capture device 108, based, for example on a signal strength received by each of a plurality of signal bases. The triangulated location may be used to verify the locations of each of the virtual spatial anchors in the global frame of reference and thereby mitigate errors.

At block 435, server 104 stores the virtual spatial anchors as anchor points in association with their corresponding regions and locates them within space 102 in the global anchor map based on the global frame of reference. The global anchor map may be stored in database 120 for future reference.

FIG. 4C depicts another example method 440 of defining a global anchor map using determined locations as anchor points. The determined locations may be objectively defined positions based on positional tracking devices (e.g., AirTag devices, GPS, Wifi and/or Bluetooth signal-based fingerprinting, etc.), triangulated locations based on signal strength relative to two or more signal bases, or the like.

At block 445, server 104 obtains a determined location of data capture device 108 according to a global frame of reference. For example, data capture device 108 may define the determined location as the origin of a local representation of the region being captured by data capture device 108. That is, prior to capturing the local representation of a region, data capture device 108 may define its present location as the determined location to be used as an anchor point for the global anchor map. Data capture device 108 may determine its location and transmit its location to server 104 as the determined location, or data capture device 108 may transmit a signal to server 104 to determine the location of data capture device 108.

For example, data capture device 108 may include a positional tracking device such as an AirTag, a GPS, or the like, which may be used to obtain an objective position for data capture device 108. This objective position may be utilized as the determined location of data capture device 108 and transmitted to server 104. The frame of reference used by the positional tracking device to define the objective position may therefore also be used as the global frame of reference by server 104.

In another example, data capture device 108 may include a receiver to detect a wireless signal, such as a Bluetooth signal, a WiFi signal, or the like. In particular, the receiver may detect wireless signals of varying strengths from three or more fixed signal sources. Based on the strength of the wireless signal detected, data capture device 108 may triangulate its location relative to the signal sources. The fixed signal sources and their defined locations may define the global frame of reference used to define the triangulated locations of data capture device 108. The triangulated locations may be utilized as the determined location of data capture device 108.

In some examples, after defining the determined location, a user of data capture device 108 may capture a local representation of the region.

At block 450, server 104 defines the determined location defined at block 445 as an anchor point and associates the determined location to its corresponding region.

At block 455, server 104 stores the determined locations as anchor points in association with their corresponding regions and locates them within space 102 in the global anchor map based on the global frame of reference. The global anchor map may be stored in database 120 for future reference.

Other manners of defining the global anchor map at block 210 of FIG. 2 are also contemplated. Additionally, blocks 205 and 210 may be performed dynamically and/or simultaneously to optimize respective criteria (e.g., threshold sizes, distances, etc.) for the regions and the anchor points. For example, if a threshold distance is applied to the anchor points, regions which are too large to locate anchor points within the threshold distance may be redefined to satisfy the threshold distance or other criteria applied to the anchor points. The anchor points may be selected and defined functionally based on the physical layout features of the space (e.g., to be close to a door of a room, a distinct feature, or the like).

At block 220, server 104 obtains, for each region, a local representation representing the region. The local representation may be, for example, a 3D representation including image data and depth data captured by data capture device 108. Accordingly, at block 220, server 104 may receive the captured local representation from data capture device 108. In other examples, server 104 may retrieve, for example from database 120, a stored local representation that was previously captured.

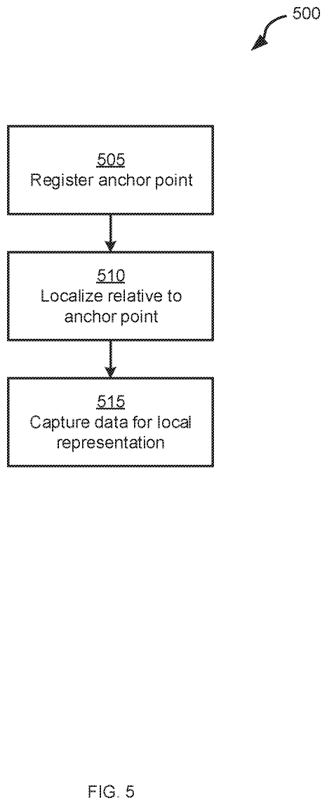

In particular, the local representation is captured in a local frame of reference which may be defined relative to the anchor point for the region. For example, turning now to FIG. 5, an example method 500 of capturing a local representation is depicted. Method 500 is described in conjunction with its performance by data capture device 108.

At block 505, data capture device 108 registers an anchor point. For example, when the anchor points are physical features, data capture device 108 may use a camera or optical sensor to scan a QR code, other barcode, or to otherwise identify a physical feature serving as an anchor point. When the anchor points are virtual spatial anchors, data capture device 108 may localize itself with respect to its environment, and use detected distinguishable features to locate the virtual spatial anchor. When the anchor points are determined locations, registration of the anchor point may occur when the determined location is defined (i.e., as part of block 450 of method 400).

At block 510, data capture device 108 localizes itself relative to the anchor point registered at block 505. In particular, data capture device 108 may capture image and/or depth data about the anchor point to allow it to determine its location. Data capture device 108 may then establish a local frame of reference based on its localization. In some examples, the localization may be performed relative to the anchor point. That is, the anchor point may be defined with a location in the local frame of reference. In other examples, the localization may be performed based on the data captured and the anchor point may simply be to identify the region in which the localization is performed, and the localization may be performed based on the features of the region.

At block 515, data capture device 108 captures data representing the region. For example, data capture device 108 may capture image data and depth data representing the region according to the local frame of reference.

In some examples, after registering the anchor point, server 104 may communicate the region to data capture device 108 to map the region onto a current field of view of data capture device 108. Data capture device 108 may then emphasize the region for which to capture data using an augmented reality component such as an overlay on the current data capture view at data capture device 108.

After capturing the local representation of the region, data capture device 108 may send the local representation to server 104 and/or database 120 for storage. In some examples, server 104 may apply post processing to the local representation, for example to limit the local representation to the designated region defined at block 205. As will be appreciated, such limitations may ensure that the local representation is within the threshold size, dimension, and other criteria used to segment space 102 or 302. Accordingly, it may be assumed that the local representation captured at block 515 experiences little to no spatial drift during the data capture operation.

Returning again to FIG. 2, at block 220, server 104 generates a global representation of space 102 or space 302 using the local representations obtained at block 220. In particular, server 104 uses the global anchor map defined at block 210 to locate the local representations in the global frame of reference based on the associated anchor point for each region.

For example, when the anchor point is defined in the local frame of reference, the global anchor map may be used to define a mapping between the local frame of reference and the global frame of reference for the given region. The local representation may thus be mapped using said corresponding defined mapping to the global frame of reference. In some examples, when more than one anchor point is defined per region, mapping each anchor point from the local frame of reference to the global frame of reference may assist in defining rotational orientation and scale of the local frame of reference relative to the global frame of reference. Accordingly, it may be advantageous to define more than one anchor point per region at block 210.

When the anchor point is simply associated with the local representation, the global anchor map may be used to map the local representation to its corresponding region in the global frame of reference. In some examples, the global and local frame of reference may be expected to be generally of similar scale, and hence the local representation may be expected to substantially correspond to the designated region. In other examples, server 104 may apply predefined rules, for example, for the local representation to be scaled to substantially fill the space of the designated region.

At block 225, server 104 stores the global representation generated at block 220, for example at database 120. In some examples, server 104 may additionally cooperate with client device 112 and/or data capture device 108 to display the global representation. For example, the global representation may be presented as a navigable 3D representation at client device 112.

In some examples, at block 225, server 104 may additionally generate a scene graph for the global representation, for example with each node represented by one or more local representations. Each local representation may be divided into nodes, in turn, representing certain regions of the local representation, for example based on a region around each anchor point within a local representation. In some examples, the scene graph may be structured as an octree, a quadtree, or a spheretree in an organized hierarchy. Thus, portions of the global representation, including multiple local representations, may be associated with one another as part of a single node based on the hierarchy of the scene graph. Similarly, portions of each local representation may be divided out into different nodes based on the hierarchy of the scene graph.

Subsequently, for example on rendering the navigable 3D representation at client device 112, server 104 may apply a level of detail technique to retrieve and render certain portions of the global and/or local representations according to the nodal hierarchy of the scene graph. The segmentation of the global representation into local representations may allow for efficient and structured division for the scene graph, while maintaining completeness and contextual spatial accuracy. Further, this segmentation allows efficient retrieval of spatial data to be rendered as a representation at client device 112.

In further examples, the blocks of method 200 need not be performed in the order described above. For example, rather than first segmenting the space into regions and defining a global anchor map, server 104 may generate the global anchor map dynamically based on local representations. That is, server 104 may first obtain local representations for respective regions, for example, after data capture device 108 identifies anchor points and obtains respective local representations in local frames of reference defined relative to the anchor points. Server 104 may subsequently locate the anchor points within the global frame of reference and map the local representations to generate the global representation of space 102. As further anchor points and further local representations are received from data capture device 108, the global representation may be dynamically updated to represent the further regions.

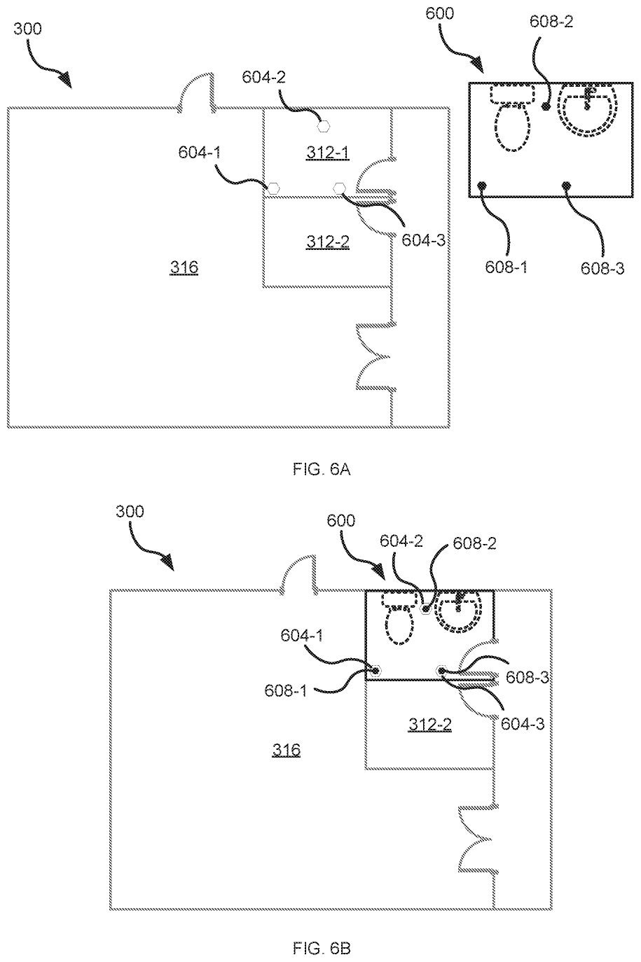

For example, the anchor points may be identified in the local representations and the global representation by a user (e.g., using client device 112 via a web portal interface to server 104), and server 104 may apply a transform based on the corresponding identified anchor points. For example, referring to FIG. 6A, server 104 may use layout map 300 as a basis for a global representation. A user may use data capture device 108 to capture a local representation 600 of the first bathroom 312-1, in the present example, depicted as including depth data.

After capturing local representation 600, the user may define anchor points 604-1, 604-2, and 604-3 in the global representation (i.e., in the global anchor map), as well as corresponding anchor points 608-1, 608-2, and 608-3 in local representation 600. As can be seen, local representation 600 may be captured at a different scale than the global representation. Accordingly, server 104 may scale and/or otherwise transform local representation 600 based on the anchor points 604 and 608 to map local representation 600 to the global representation. In the present example, anchor points 604 and 608 are co-planar, but in other examples, the anchor points may be located in 3D space to rotate, orient and scale local representation 600 in 3D space.

As seen in FIG. 6B, server 104 transforms local representation 600 to locate local representation 600 in the global representation. In particular, corresponding anchor points 604 and 608 may be located at the same respective positions as one another.

As will be appreciated, other manners of generating a global representation using anchor points and local representations are also contemplated.

As described above, an example system segments spaces into sufficiently small regions that local representations of the regions experience little to no spatial drift. The local representations may then be mapped to a global representation based on an associated anchor point and a global anchor map. Since each of the representations individually experience little to no spatial drift, and the global anchor map is defined to experience little to no spatial drift, the resulting global representation provides a more robust representation of the space with reduced spatial drift.

The system therefore provides an improvement on conventional techniques for capturing spatial data (e.g., including image data and depth data) representing a space and segmenting, organizing and storing the spatial data and relationships between segments of the spatial data. Specifically, the segmentation allows increases the consistency of the representation internally, and as an accurate representation of the space. Further, segmentation of the captured spatial data allows local representations to be efficiently associated with nodes to create a scene graph corresponding to the global representation. The scene graph my then be used during rendering to reduce the computational complexity of rendering portions of the scene according to a level of detail methodology.

The scope of the claims should not be limited by the embodiments set forth in the above examples but should be given the broadest interpretation consistent with the description as a whole.

1. A method of generating a representation of a space, the method comprising:
segmenting the space into a plurality of regions;
defining a global anchor map defining at least one anchor point in association with each region and locating the anchor points within the space according to a global frame of reference;
obtaining, for each region, a local representation representing the region according to a local frame of reference;
generating a global representation in the global frame of reference based on the local representation, the at least one anchor point associated with each region, and the global anchor map; and
storing the global representation as the representation of the space.

2. The method of claim 1, wherein each region comprises at most a threshold size.

3. The method of claim 1, wherein segmenting the space comprises:
obtaining a layout map defining physical layout features of the space; and
segmenting the space according to the physical layout features.

4. The method of claim 1, wherein the anchor points comprise physical features.

5. The method of claim 4, wherein locating the anchor points within the space comprises measuring a physical distance between physical features.

6. The method of claim 1, wherein the anchor points comprise virtual spatial anchors.

7. The method of claim 6, locating the anchor points within the space comprises:
localizing a data capture device to establish the global frame of reference;
tracking a location of the data capture device within the established global frame of reference;
identifying, at the data capture device, a first virtual spatial anchor and a second virtual spatial anchor; and
determining, based on the tracked location of the data capture device, a distance between the first and second virtual spatial anchors.

8. The method of claim 6, wherein the virtual spatial anchors are located within a threshold distance of one another.

9. The method of claim 1, wherein the anchor points comprise determined locations.

10. The method of claim 9, wherein locating the anchor points within the space comprises:
tracking, at a data capture device, an objective position of the data capture device via a positional tracking device; and
defining the objective position as the determined location.

11. The method of claim 9, wherein locating the anchor points within the space comprises:
detecting, at a data capture device, a wireless signal from three or more fixed signal sources; and
triangulating a location of the data capture device relative to the signal sources; and
defining the triangulated location as the determined location.

12. The method of claim 1, wherein segmenting the space and defining the global anchor map are performed dynamically to optimize respective criteria for the regions and the anchor points.

13. The method of claim 1, wherein obtaining the local representation comprises:
registering, at a data capture device, one of the anchor points;
localizing the data capture device relative to the anchor point to establish the local frame of reference; and
capturing the local representation in the local frame of reference.

14. The method of claim 13, wherein localizing the data capture device further comprises locating the anchor point within the local frame of reference.

15. The method of claim 14, wherein generating the global representation comprises:
using global anchor map to define a mapping between the local frame of reference and the global frame of reference for each region; and
mapping the local representation for each region to the global frame of reference based on the corresponding defined mapping for the region.

16. The method of claim 1, further comprising generating a scene graph for the global representation, wherein each node in the scene graph comprises one or more local representations.

17. A server comprising:
a memory and a communications interface; and
a processor interconnected with the memory and the communications interface, the processor configured to:
segment a space into a plurality of regions;
define a global anchor map defining at least one anchor point in association with each region and locating the anchor points within the space according to a global frame of reference;
obtain, for each region, a local representation representing the region according to a local frame of reference;
generate a global representation in the global frame of reference based on the local representation, the at least one anchor point associated with each region, and the global anchor map; and
store the global representation of the space.

18. A method of generating a representation of the space, the method comprising:
identifying an anchor point;
obtaining, for a region of the space, a local representation representing the region according to a local frame of reference, wherein the local frame of reference is defined relative to the anchor point;
determining a location of the anchor point within a global frame of reference;
generating a global representation in the global frame of reference based on the local representation and the location of the anchor point within the global frame of reference; and
storing the global representation as the representation of the space.

19. The method of claim 18, further comprising:
identifying a further anchor point;
obtaining, for a further region of the space, a further local representation representing the further region according to a further local frame of reference, wherein the further local frame of reference is defined relative to the further anchor point;
determining a further location of the further anchor point within the global frame of reference; and
updating the global representation in the global frame of reference based on the further local representation and the further location of the further anchor point within the global frame of reference.

20. The method of claim 18, further comprising generating a scene graph for the global representation, wherein each node in the scene graph comprises one or more local representations.

21. The method of claim 20, further comprising rendering a 3D representation and applying a level of detail technique according to the scene graph.
